(19) United States
(12) Patent Application Publication
(10) Pub. No.: US 2016/0058532 A1
(43) Pub. Date: Mar. 3, 2016

(54) Toothbrush Assembly

(71) Applicant: Justyn Ramharack, Scarborough (CA)

(72) Inventor: Justyn Ramharack, Scarborough (CA)

(21) Appl. No.: 14/471,266

(22) Filed: Aug. 28, 2014

(51) Int. Cl. A61C 17/22; A61C 17/34

(52) U.S. Cl. CPC A61C 17/222; A61C 17/3418

(57) ABSTRACT

A toothbrush assembly for cleaning a user's teeth includes a housing. A motor is coupled to the housing. A shaft is coupled to motor. The motor rotates the shaft. A brush is structured to have a cylindrical shape. The brush is movably coupled to the housing. The brush is coupled to the shaft. The shaft rotates the brush along a longitudinal axis so the brush may clean teeth. An actuator is coupled to the housing. The actuator is operationally coupled to the motor. The actautor actuates the motor between a first direction and a second direction.

### BACKGROUND OF THE DISCLOSURE

### Field of the Disclosure

The disclosure relates to toothbrush devices and more particularly pertains to a new toothbrush device for cleaning a user's teeth.

### SUMMARY OF THE DISCLOSURE

An embodiment of the disclosure meets the needs presented above by generally comprising a housing. A motor is coupled to the housing. A shaft is coupled to motor. The motor rotates the shaft. A brush is structured to have a cylindrical shape. The brush is movably coupled to the housing. The brush is coupled to the shaft. The shaft rotates the brush along a longitudinal axis so the brush may clean teeth. An actuator is coupled to the housing. The actuator is operationally coupled to the motor. The actautor actuates the motor between a first direction and a second direction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a toothbrush assembly according to an embodiment of the disclosure.

FIG. 2 is a right side view of an embodiment of the disclosure.

FIG. 3 is a cross sectional view taken along line 3-3 of FIG. 1 of an embodiment of the disclosure.

FIG. 4 is a top view of an embodiment of the disclosure.

### DESCRIPTION OF THE PREFERRED EMBODIMENT

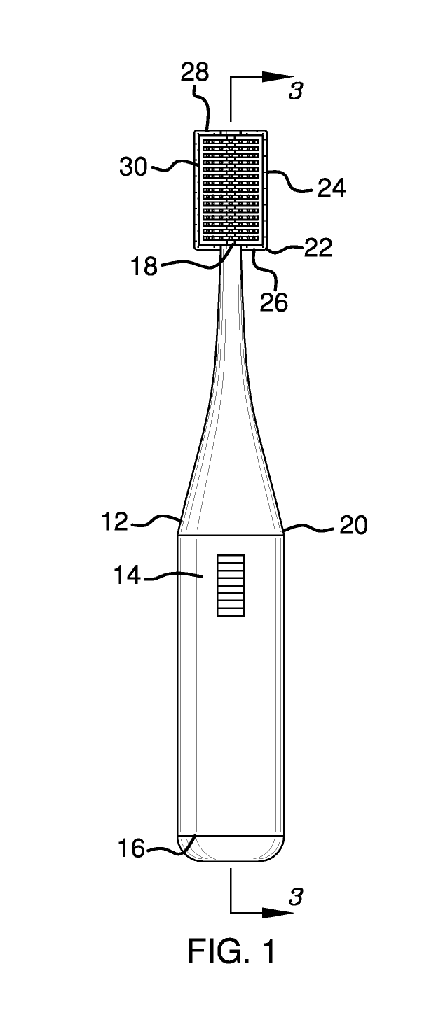

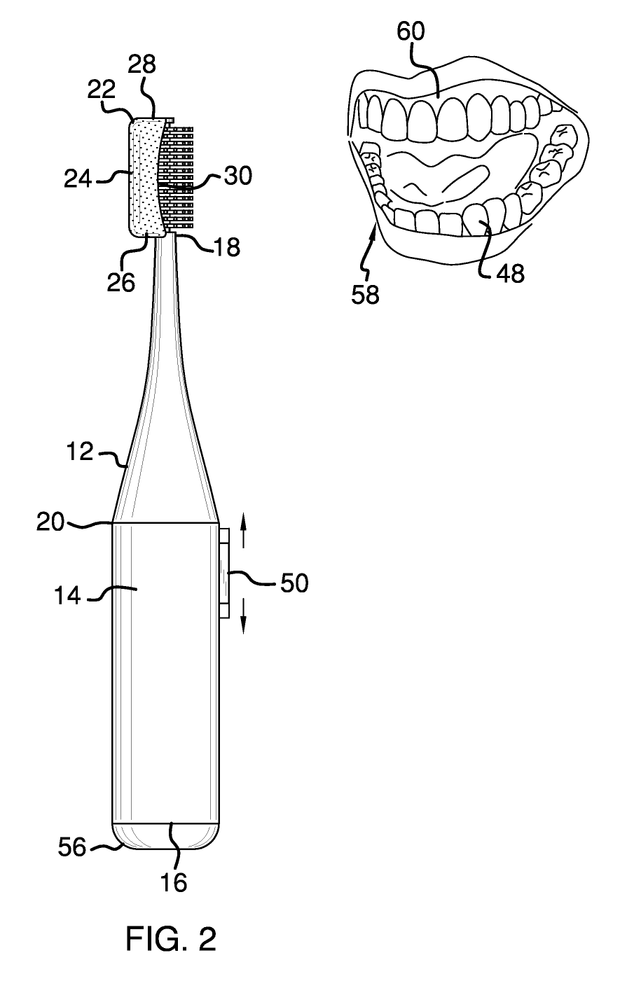

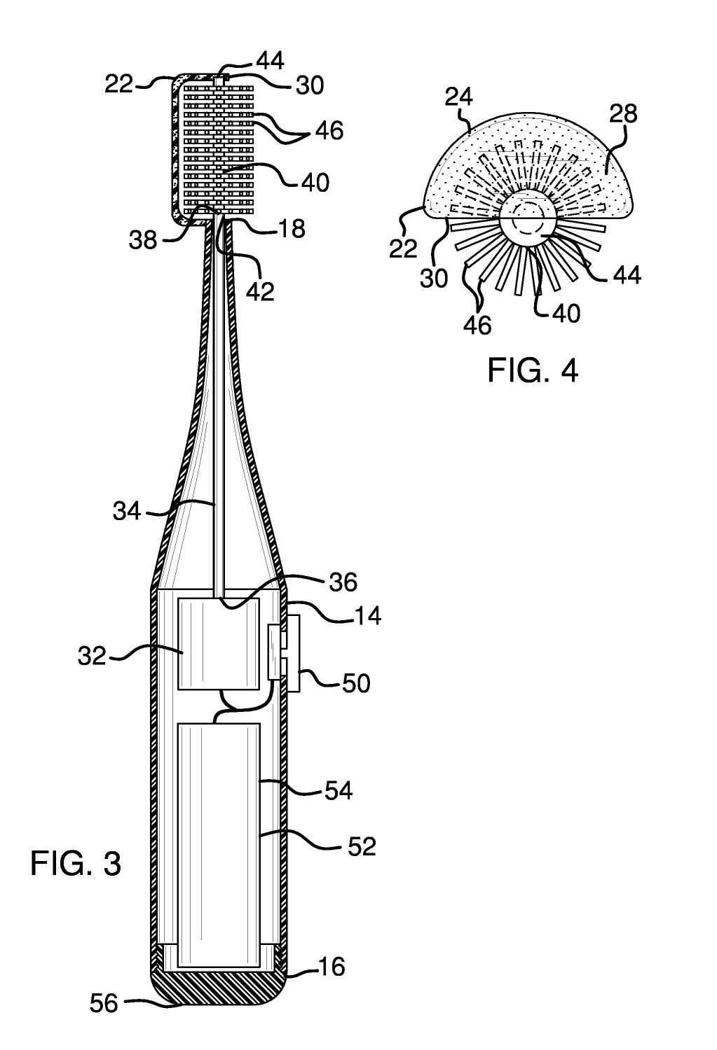

With reference now to the drawings, and in particular to FIGS. 1 through 4 thereof, a new toothbrush device embodying the principles and concepts of an embodiment of the disclosure and generally designated by the reference numeral 10 will be described.

A housing 12 is provided. The housing 12 has an outer wall 14 extending between each of a first end 16 and a second end 18 of the housing 12. The housing 12 is substantially hollow. Each of the first 16 and second 18 ends of the housing 12 is open. Additionally, the outer wall 14 of the housing 12 tapers between a middle 20 of the housing 12 and the second end 18 of the housing 12.

A guard 22 has a perimeter wall 24 extending between each of a coupled end 26 a free end 28 of the guard 22. The perimeter wall 24 of the guard 22 is curved so the guard 22 has a semi-cylindrical shape. A forward side 30 of the perimeter wall 24 of the guard is open. The coupled end 26 of the guard 24 is coupled to the second end 18 of the housing 12. The guard 26 may be comprised of a resiliently compressible material.

A motor 32 is coupled to the housing 12. The motor 32 may be an electric motor of any conventional design. A shaft 34 is provided. The shaft 34 has a primary end 36 and a secondary end 38. The primary end 36 of the shaft 34 is rotatably coupled to the motor 32. Moreover, the secondary end 38 of the shaft 34 is directed outwardly through the second end 18 of the housing 12 and the coupled end 26 of the guard 22.

A brush 40 has an initial end 42 and an alternative end 44. The initial end 42 of the brush 40 is rotatably coupled to the secondary end 38 of the shaft 34. The shaft 34 rotates the brush 40 along a longitudinal axis extending through the initial 42 and alternative 44 ends of the brush 40. The alternative end 44 of the brush 40 is rotatably coupled to the free end 28 of the guard 22. The guard 22 surrounds the brush 40.

A plurality of bristles 46 is each coupled to and extends outwardly from the brush 40. The plurality of bristles 46 is evenly distributed around an entire circumference of the brush 40. The plurality of bristles 46 is further evenly spaced apart and distributed between the initial 42 and alternative 44 ends of the brush 40. The brush 40 may clean a user's teeth 48.

An actuator 50 is coupled to the housing 12. The actuator 50 is electrically coupled to the motor 32. The actautor 50 actuates the motor 32 between a first direction and a second direction. The motor 32 rotates the brush 40 in a clockwise direction when the actuator 50 is positioned in the first direction. The motor 32 rotates the brush 40 in a counter clockwise direction when the actuator 50 is positioned in the second direction.

A power supply 52 is coupled to the housing 12. The power supply 52 is electrically coupled to the actuator 50. Additionally, the power supply 52 comprises at least one battery 54. The battery 54 is positioned within the first end 16 of the housing 12. A cap 56 threadably engages the first end 16 of the housing 12. The cap 56 closes the first end 16 of the housing 12.

In use, the brush 40 is positioned within the user's mouth 58. The guard 22 cushions the user's gums 60 when the brush 40 is positioned within the user's mouth 58. The actuator 50 is actuated in either the first or second directions. The actuator 50 may be switched between the first and second directions at any time. The assembly 10 is utilized in the convention of brushing teeth.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A toothbrush assembly comprising:
a housing;
a motor coupled to said housing;
a shaft coupled to motor such that said motor rotates said shaft;
a brush structured to have a cylindrical shape, said brush being movably coupled to said housing, said brush being coupled to said shaft such that said shaft rotates said brush along a longitudinal axis wherein said brush is configured to clean teeth; and
an actuator coupled to said housing, said actuator being operationally coupled to said motor such that said actautor actuates said motor between a first direction and a second direction; and
a guard having a perimeter wall extending between each of a coupled end a free end of said guard, said perimeter wall of said guard being curved such that such that said guard has a semi-cylindrical shape, a bottom side of said perimeter wall of said guard being open, said guard having a pair of longitudinal edges extending between said coupled end and said free end, each of said longitudinal edges being concavely arcuate.

2. The toothbrush assembly according to claim 1, further comprising said housing having an outer wall extending between each of a first end and a second end of said housing, said housing being substantially hollow, each of said first and second ends of said housing being open.

3. The toothbrush assembly according to claim 2, further comprising said shaft having a primary end and a secondary end, said primary end of said shaft being rotatably coupled to said motor such that said secondary end of said shaft is directed outwardly from said second end of said housing.

4. (canceled)

5. The toothbrush assembly according to claim 1, further comprising said coupled end of said guard being coupled to a second end of said housing.

6. The toothbrush assembly according to claim 5, further comprising said brush having an initial end and an alternative end, said initial end of said brush being rotatably coupled to a secondary end of said shaft, said alternative end of said brush being rotatably coupled to said free end of said guard such that said guard surrounds said brush.

7. The toothbrush assembly according to claim 6, further comprising a plurality of bristles each coupled to and extending outwardly from said brush such that said plurality of bristles is evenly distributed around an entire circumference of said brush, said plurality of bristles further being evenly spaced apart and distributed between said initial and alternative ends of said brush.

8. The toothbrush assembly according to claim 1, further comprising a power supply coupled to said housing.

9. The toothbrush assembly according to claim 8, further comprising said power supply being electrically coupled to said actuator.

10. The toothbrush assembly according to claim 9, further comprising said power supply comprising at least one battery.

11. A toothbrush assembly comprising:
a housing having an outer wall extending between each of a first end and a second end of said housing, said housing being substantially hollow, each of said first and second ends of said housing being open;
a guard having a perimeter wall extending between each of a coupled end a free end of said guard, said perimeter wall of said guard being curved such that such that said guard has a semi-cylindrical shape, a bottom side of said perimeter wall of said guard being open, said coupled end of said guard being coupled to said second end of said housing, said guard having a pair of longitudinal edges extending between said coupled end and said free end, each of said longitudinal edges being concavely arcuate;
a motor coupled to said housing;
a shaft having a primary end and a secondary end, said primary end of said shaft being rotatably coupled to said motor such that said secondary end of said shaft is directed outwardly from said second end of said housing and said coupled end of said guard;
a brush having an initial end and an alternative end, said initial end of said brush being rotatably coupled to said secondary end of said shaft such that said shaft rotates said brush along a longitudinal axis extending through said initial and alternative ends of said brush, said alternative end of said brush being rotatably coupled to said free end of said guard such that said guard surrounds said brush;
a plurality of bristles each coupled to and extending outwardly from said brush such that said plurality of bristles is evenly distributed around an entire circumference of said brush, said plurality of bristles further being evenly spaced apart and distributed between said initial and alternative ends of said brush wherein said brush is configured to clean teeth;
an actuator coupled to said housing, said actuator being electrically coupled to said motor such that said actautor actuates said motor between a first direction and a second direction; and
a power supply coupled to said housing, said power supply being electrically coupled to said actuator, said power supply comprising at least one battery.
